(19) United States
(12) Patent Application Publication
(10) Pub. No.: US 2008/0007470 A1
(43) Pub. Date: Jan. 10, 2008

(54) Satellite dish de-icing system

(76) Inventor: Chris M. Ward, Ogden, UT (US)

Correspondence Address: SUNG I. OH, PROFESSIONAL LAW CORPORATION, 710 QUAIL VALLEY LANE, WEST COVINA, CA, 91791, US

(21) Appl. No.: 11/482,008

(22) Filed: Jul. 6, 2006

(51) Int. Cl. H01Q 1/02

(52) U.S. Cl. 343/704; 343/840

(57) ABSTRACT

A satellite dish has electrical resistance heating wires embedded therein. The wires are a portion of a circuit that includes an on/off switch located inside a residence associated with the satellite dish and a power source associated with the residence. Whenever snow or ice builds up on the dish, the on/off switch is operated to activate the heating wires to melt the snow or ice from the dish.

### TECHNICAL FIELD OF THE INVENTION

The present invention relates to satellite antennas and, in particular, concerns a system for heating an earth based satellite antenna to prevent accumulations of snow and ice on the antenna.

### BACKGROUND OF THE INVENTION

Satellite communication systems are becoming increasingly popular in today's world. For example, satellite communication systems are being used by networks of stores for providing inventory information between stores and these systems are also used for credit transactions. In particular, satellite communication systems have increasingly been used by retail stores to approve credit card transactions by individual customers. The primary advantage of satellite communications is that the information can be transmitted to a satellite and then returned to a distant ground station much quicker than the information can be transferred via the telephone lines.

Therefore, the use of dish antennas, particularly for receiving signals from satellites, is increasing rapidly. Dish antennas vary widely in size, but many have diameters of 1 to 7 meters; for example, 1.2 meter and 1.8 meter aperture antennas are most frequently used for signals in the 12-14 GHz band which is widely used for private networks transmitting data, voice and video communications. FCC Regulation 25.209 sets radiation pattern sidelobe envelope requirements for both transmit and receive antennas, and a major concern of antenna manufacturers and users is to ensure not only that antennas meet those requirements when first manufactured, but also that they do not become distorted subsequently, so that the requirements are no longer met.

The increasing use of satellite communications has resulted in the installation of many satellite dish antennas in colder climates. During winter season, snow and ice often accumulate on the dish reflectors of satellite earth stations and microwave antennas. Since the antenna is essentially a bowl-shaped object inclined upwardly at a particular angle so that the electrical bore site of the antenna is pointed at a synchronous satellite of interest, such accumulation or build-up is normally not uniform over the entire antenna surface. Rather, the lower portion of the antenna, being flatter and inclined at less of an angle, tends to accumulate a greater thickness of ice or snow. This uneven build-up distorts the normal reflecting surface of the antenna such that in the case of a receiving antenna, the received signals are no longer concentrated at the antenna focal point where the receiving components are located. Rather, the reflecting surface now distorted by snow and ice build-up, reflects the receive signals to a displaced focal point causing a substantial loss in receiving signal strength. In some cases, ice and snow may accumulate in a more or less uniform layer over the reflecting surface of the antenna causing a loss in antenna gain due to attenuation of the reflected signal as it passes through the ice and snow layer. Since water is a dielectric, accumulation of ice and snow reduce the performance of these antenna dishes. Antenna dishes that use fixed low power levels and high frequencies signals with short wavelengths, for example satellite communication antennas, are particularly susceptible to the problems of ice and snow accumulation.

Various ice resistant and ablative chemical coatings have been developed to prevent ice and snow from forming and accumulating on antenna dishes. Chemical compounds, such as isopropyl alcohol, urea, ethylene, and propylene glycol, reduce moisture buildup by lowering the freezing point of water. Chemical coatings, however, have not provided adequate protection and often cause secondary problems, including environmental hazards, fires and excess cost. For maximum effectiveness, chemicals must be applied to the antenna reflector prior to the accumulation of the ice and snow. Coating tends to coalesce water into droplets, when the droplets increase to a critical size, they flow off the antenna reflector. In freezing temperatures, these droplets may freeze and aggravate the problem. The coatings are not effective at extremely low temperatures and have a limited life span.

Teflon coated glass fabrics used as a reflector covers or radomes have been developed to prevent ice from developing a strong enough bond for adhesion. This type of surface covering is effective only for a few seasons. Eventually, the sun's ultraviolet radiations causes cracks to form in the Teflon surface which allows the ice to bond to the surface.

Still further, several features have been developed in the past to address the problem of accumulations of snow and ice in satellite dish antennas. Satellite antennas have been equipped with fabric covers to prevent snow and ice from accumulating inside of the dish of the antenna. These covers are preferably made of a material that does not interfere with the signals traveling between the satellite and the antenna. One difficulty with these covers, however, is that, while these covers are generally successful in keeping snow and water from accumulating inside of the dish, these covers will quite often be coated by snow or frozen water in certain conditions.

In particular, when there is a wet snow, the wet snow has a tendency to stick to the outside cover of the satellite dish. Similarly, when weather conditions are producing sleet or freezing fog, the frozen ice can also accumulate on the outside cover of the antenna. When either of these conditions occur, communications between the satellite and the earth based antenna can be interrupted.

From the foregoing it is apparent that there is a need for a system that reduces the disruption of communications between satellites and earth based antennas as a result of inclement weather. To this end, there is a need for an improved system of preventing accumulations of snow and ice, and in particular, preventing accumulations of wet snow or ice, from interrupting communications between a satellite and a ground based antenna.

### SUMMARY OF THE INVENTION

The above-discussed disadvantages of the prior art are overcome by a satellite dish having electrical resistance heating wires embedded therein. The wires are a portion of a circuit that includes an on/off switch located inside a residence associated with the satellite dish and a power source associated with the residence. Whenever snow or ice builds up on the dish, the on/off switch is operated to activate the heating wires to melt the snow or ice from the dish.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a satellite dish incorporating the de-icing system embodying the present invention.

FIG. 2 is a view of detail A of FIG. 1 showing the heating wires embedded in the satellite dish in accordance with the teaching of the present invention.

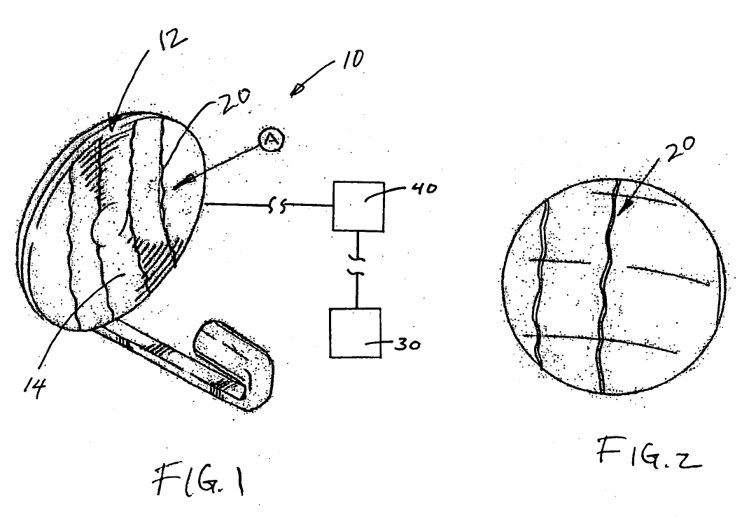

### DETAILED DESCRIPTION OF THE INVENTION

Referring to the figures, it can be understood that the present invention is embodied in a satellite dish de-icing system 10 which comprises a satellite dish 12 having a concave surface 14. Snow and/or ice may build up on the surface thereby interfering with reception. Therefore, system 10 includes an electrical resistance heating wire 20 embedded in the satellite dish and extending for essentially the entire surface of the satellite dish. The wire will generate heat when power is applied thereto, and by covering essentially the entire surface of the dish, all the snow and/or ice will be melted when the wire is activated.

A power source 30, such as utility power to a home, is located inside a building associated with the satellite dish, and an on/off switch 40 is electrically interposed between the power source and the heating wire to electrically connect the heating wire to the power source when the on/off switch is in an “on” condition.

Whenever snow or ice on the satellite dish begins interfering with reception of the equipment associated with the dish, switch 40 is activated to apply power to the heating wire in the dish. Once reception is restored, the switch can be moved to the “off” position to interrupt power application to the wire. A temperature sensor can be placed in the dish as well to automatically sense the presence of ice or snow and automatically apply power to the heating wire.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

1. A satellite dish de-icing system consisting of:
A) a satellite dish having a concave surface;
B) an electrical resistance heating wire embedded in the satellite dish and extending for essentially the entire surface of the satellite dish;
C) a power source located inside a building associated with the satellite dish; and
D) an on/off switch electrically interposed between the power source and the heating wire to electrically connect the heating wire to the power source when the on/off switch is in an “on” condition.

2. A satellite dish de-icing system consisting of:
A) a satellite dish having a concave surface; and
B) an electrical resistance heating wire embedded in the satellite dish and extending for essentially the entire surface of the satellite dish.
